(19) United States
(12) Patent Application Publication
(10) Pub. No.: US 2008/0061140 A1
(43) Pub. Date: Mar. 13, 2008

(54) Tamper resistant packaging with security tag

(75) Inventor: Tom McMahon, New Berlin, WI (US)

Correspondence Address: FULBRIGHT & JAWORSKI, LLP, 1301 MCKINNEY, SUITE 5100, HOUSTON, TX, 77010-3095, US

(73) Assignee: Consolidated Graphics, Inc.

(21) Appl. No.: 11/518,134

(22) Filed: Sep. 8, 2006

(51) Int. Cl. G06Q 30/00; G08B 13/14

(52) U.S. Cl. 235/385; 340/572.1

(57) ABSTRACT

The present invention is directed to a system and method for preventing product theft using a security package for a product. The system, in one embodiment, includes a package custom designed for each product such that the package may not easily be removed without the assistance of a tool. The package further includes a security device placed on the inside of the package not easily viewable by the customer where the security device activates a security system placed at the exits of a retail establishment. The package, in one embodiment, is constructed from a material that cannot be easily torn such as rigid vinyl. The package is constructed by die cutting the material, attaching the security device, wrapping the material around the product and sealing the package using an adhesive that creates an extremely strong bond between overlapping portions of the material.

### TECHNICAL FIELD

The present invention relates to theft-prevention of a product. More specifically, the present invention relates to theft-prevention of a product using a tamper resistant security device detectable by a sensor.

### BACKGROUND OF THE INVENTION

In the retail industry, certain products may be subject to frequent theft, also known as inventory shrink. In order to prevent such thefts, many retailers have installed security scanners at store exits. These scanners are designed to detect a security device previously placed on the product or product packaging. Such detection may involve the use of several different technologies well known in the art. For example, the security device and scanner may use radio frequency, magnetic, acoustic magnetic, dual resonator, RFID technology, and/or the like. In one configuration, the scanner may detect any security device placed in proximity to the scanner. In this configuration, the security device must be removed from the product at checkout. Such a system is often employed in conjunction with clothing sales. Often the security device consists of two bulky pieces placed on either side of a piece of fabric connected by a thin pin piercing the fabric where the device can be removed only by a special machine placed at the checkout counter.

In another configuration, the scanner may be configured to detect only those security devices not deactivated at the checkout. Such a system is often used in conjunction with consumer electronics. For example, the security device may be placed on the inside of the package containing the consumer electronic, such as the inside of a DVD case or the inside of a cardboard box containing a digital camera. As another example, the security device may be attached to the outside of a package, such as a “clamshell” plastic package. The security device may then be deactivated, for example, when placed in proximity to a deactivation device by an employee at a checkout counter.

To defeat these security measures, a thief may attempt to separate a product from the packaging containing the security device. For some packages, such as, for example, a typical DVD package, this may be extremely difficult because the package may be sealed with shrink wrap preventing the thief from opening the package and removing the product from the package. However, such packaging is expensive and creates a large amount of waste when the customer eventually removes the product from the package. Further, for some products, completely enclosing a product with a case or box may not be practical due to concerns such as limited shelf space.

### BRIEF SUMMARY OF THE INVENTION

The present invention is directed to a system and method for preventing product theft using a security package for a product. Embodiments of the invention provide for a package custom designed to fit a product such that the package covers a portion of the product without completely enclosing the product and the package may not be separated from the product without tearing or breaking the package. The package may be constructed using a material that cannot be easily torn without the assistance of a tool and an adhesive that produces bonds that cannot easily be broken. As such, the package cannot be easily broken—and thus separated from the product—without the assistance of a tool such as a knife. Embodiments of the invention further provide for a security device placed on the inside of the security package not easily seen from the outside of the package. The security device interacts with a scanner placed at store exits to detect unauthorized attempts to remove the product from the store.

In one embodiment, a security package is constructed using a sheet of material that cannot be easily torn without the assistance of a tool where such property may be indicated by the material possessing a tensile strength at least a magnitude greater than paper-based packaging material of the same thickness. The material may be rigid vinyl, in some embodiments, with a thickness between 10 and 20 mil. In some embodiments, graphics or text may be printed on the material. Thus, the material may have the appearance of paper or cardboard, but is much more resistant to tearing than paper or cardboard. The material may be die cut. The shape of the material after cutting may be designed specifically to accommodate a specific product or product line. The shape of the cut material is designed to allow the material to be wrapped around the product such that, when sealed, the product may not be separated from the package without breaking or tearing the package. A security device may be attached to the material. In one embodiment, the security device is placed on one face of the material such that when the material is wrapped around the product, the security device is not easily visible. Once the material is wrapped around the product, the package may be sealed by using an adhesive to form an adhesive bond between two portions of the material. The adhesive may be chosen such that the adhesive forms an adhesive bond that is difficult to break without the assistance of a tool.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 illustrates a die cut sheet of material cut to fit the circuit breaker of FIG. 2 according to one embodiment of the invention;

FIG. 2 is a circuit breaker for use with one embodiment of the invention;

FIG. 3 illustrates a security package attached to the circuit breaker of FIG. 2 according to one embodiment of the invention;

FIG. 4 illustrates a die cut sheet of material cut to fit the paintbrush of FIG. 5 according to one embodiment of the invention;

FIG. 5 is a paintbrush for use with one embodiment of the invention; and

FIG. 6 illustrates a security package attached to the paintbrush of FIG. 5 according to one embodiment of the invention.

### DETAILED DESCRIPTION OF THE INVENTION

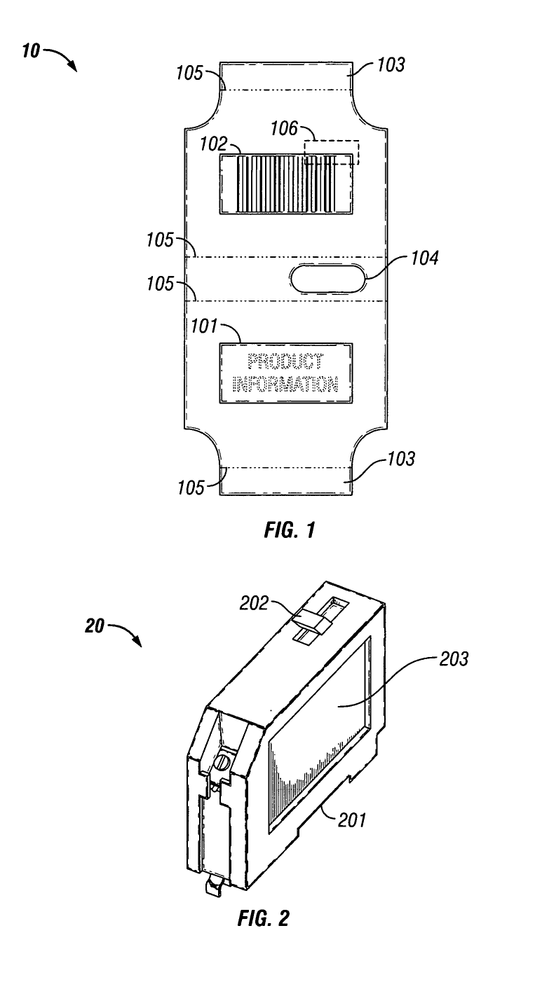

FIG. 1 illustrates a die cut sheet of material 10 according to one embodiment of the invention. Material 10 is chosen such that the material may not be easily torn without the assistance of a tool. To accomplish this goal, material 10 should possess tensile strength and/or other properties such as flexural strength, burst strength and/or tear strength significantly greater than standard paper or cardboard of similar thickness commonly used for packaging. As an example, certain laminated paper products were tested that did not provide adequate surface strength to properly resist tearing. As will be discussed below, several synthetic (i.e., not cellulose or wood based) substrates satisfy the tear-resistant criteria.

In a preferred embodiment, matte rigid vinyl (also known as rigid PVC film) is selected as material 10. The matte rigid vinyl may have a thickness of 10, 15, or 20 mil, or any other thickness appropriate for product packaging. As an example, in a preferred embodiment, 10 mil Rigid PVC Film from Alameda Company (website) possessing tensile strength measured at approximately 6000 psi using ASTM D-882 compliant testing is used. As another example, Dura-Go™ 10 mil Matte Rigid Vinyl possessing tensile strength of 5400 psi-6100 psi and flexural strength of 8400 psi-9200 psi may be used. As another example, Dura-Go™ 4 mil PFP White Polyester possessing a tensile strength of 20,000 psi in the machine direction and 24,285 psi in the transverse direction may be used. As another example, Transvy® Gloss Rigid Vinyl available in thicknesses of 5 mil to 25 mil possessing a tensile strength of 7185 psi measured using ASTM D-882 compliant testing and an impact strength under tension of 250 ft. lb/in² measured using ASTM D-1790 compliant testing may be used. As another example, 10 mil Trans Tear Resistant™ White Polypropylene Film possessing a tensile strength of 3043 psi using ATSM D-882 95A compliant testing and a tear strength of 594 grams using the Elmendorf tear test may be used. As another example, 10 mil PRO-Print® Synthetic Paper possessing a 3400 psi in the machine direction and 3000 psi in the transverse direction and tear strength of 1 lb in the machine direction and 4 lb in the transverse direction using ASTM D-1938 (initiated) compliant testing and 6.4 lb in the machine direction and 8 lb in the transverse direction using ASTM D-1004 (uninitiated) compliant testing may be used.

As a comparison, 10 mil Carolina® S1 Cover paper (commonly used for product packaging) possesses tensile strength of 37.5 psi in the cross direction and 84.7 psi in the machine direction. Thus, the matte rigid vinyl possesses a tensile strength almost two orders of magnitude greater than the Carolina® S1 Cover. Further examples of typical values of paper and cardboard packaging are known to those skilled in the art and may be found in the literature. Collaborative Testing Services, Inc. (website) produces reports listing and analyzing paper testing results from multiple labs. Collaborative Testing Service's July 2006 Paper, Paperboard & Corrugated Fiberboard Testing Program Summary Report #223S reported the following results: Tearing Strength was measured using TAPPI Official Test Method T414. For “printing papers,” the average of 71 reporting laboratories was 89.915 grams to 89.743 grams, and for “packaging papers,” the average of 56 reporting laboratories was 98.815 grams to 143.39 grams. Tensile Breaking Strength was measured using TAPPI Official Test Method T494. For “printing papers,” the average of 79 reporting laboratories was 4.9512 kN/m to 4.7988 kN/m, and for “packaging paper,” the average of 61 laboratories was 16.377 kN/m to 14.412 kN/m.

Thus, material 10 is selected to be substantially more resistant to breaking than a sheet of paper or cardboard of the same thickness. This increased resistance can be seen through the measurements illustrated above including tensile strength and tear strength. It should be understood that these values, as illustrated, are not the only values with which the invention may be used. These values merely illustrate examples of materials that are difficult to tear or break without the assistance of a tool. By using such a material in the security package, the security package is difficult to sever in the store without a tool but may be easily removed outside of the store using a tool such as a knife, scissors, and/or the like. It should be understood that while the embodiment shown utilizes a single sheet of material, other embodiments may employ more than one sheet of material. Additionally, material 10 may be chosen to have similar appearance to standard paper or cardboard packaging, thus making the change in packaging material nonobvious to the customer.

In one embodiment, in addition to its strength and similar appearance to standard paper or cardboard packaging, material 10 is selected to be capable of being easily printed upon. A typical security package may have product information 101 and bar code 102 printed directly on the material. The printing may be on one or both sides. As an example, additional product information or directions may be printed on the second side (the side facing inward when the package is assembled) of the material that may be visible to the customer after the security package is removed from the product. In addition to product information, graphics and other such elements may be printed on material 10 to attract customers to the product.

In some embodiments, material 10 is custom die cut to wrap around a specific product. The die cut may be designed such that material 10 may be wrapped around the product in such a way that the material, once sealed, cannot be separated from the product without severing the package. Put another way, once sealed, wrapped material 10 may not simply be slipped off of the product, but instead must be broken in order to be separated from the product. Such a design may utilize the shape of the product. For example, FIG. 2 illustrates device 20 as a circuit breaker. While mostly rectangular in shape, device 20 contains indentation 201 in the bottom plane and protrusion switch 202 in the top plane. Flaps 103 of material 10 are thus designed to fit securely in indention 201 and hole 104 is designed to accommodate switch 202 when material 10 is positioned around device 20.

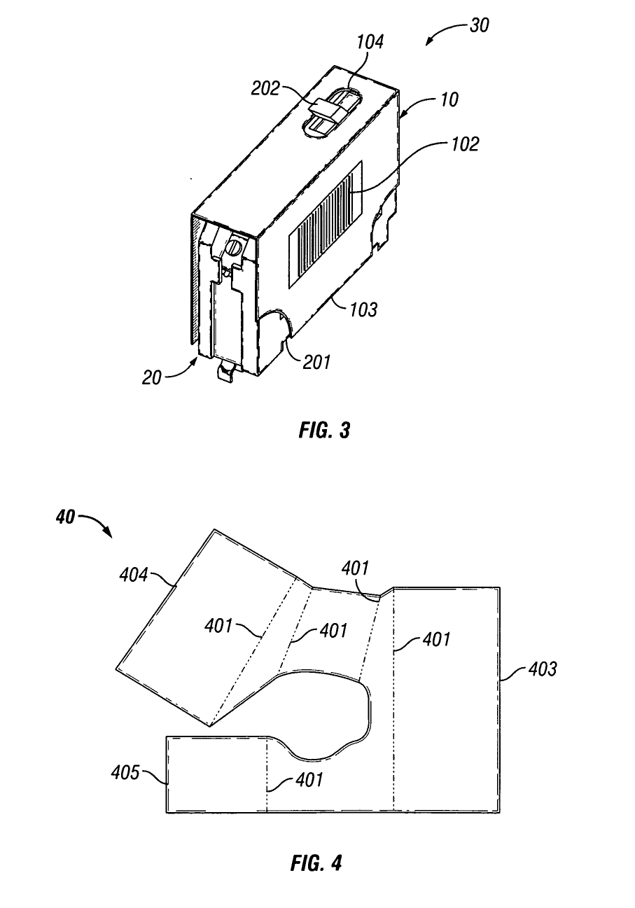

FIG. 3 illustrates how material 10 is formed around device 20 to form security package 30. As illustrated, flaps 103 and hole 104 fit securely within indentation 201 and around switch 202, respectively. Thus, by utilizing the shape of device 20, material 10 is die cut such that, once wrapped around device 20 and sealed, material 10 cannot be slid off or in any other way separated from device 20 without breaking the security package. Additionally, because security package 30 does not completely enclose device 20, such as would be the case if a standard packing box was used, less material is used reducing the cost of creating the package and generating less waste when the package is removed and product can be more easily viewed by customer. Additional substances may be applied to all or part of material 10 to increase its resistance to tearing. As an example, by repeatedly toggling switch 202 after material 10 has been formed into security package 30, an individual may be able to nick the material around hole 104 causing material 10 to become more vulnerable to tearing. To reduce this vulnerability, a thin strip of Mylar may be applied to the inner-facing surface of material 10 in the vicinity of hole 104.

Before material 10 is wrapped around a product, security device 106 is attached. In one embodiment, security device 106 is attached to the side of material 10 that will face inward when material 10 is assembled, allowing security device 106 to stay out of view of the customer. By keeping the security device out of view of the customer, a potential thief may not know of the security device and therefore will not attempt to remove it. Thus, in FIG. 1, security device 106 is illustrated as a dashed box to indicate that security device is actually not on the face of material 10 illustrated in FIG. 1, but rather is attached to the opposite face of material 10. Security device 106, in some embodiments, may be contain technology such as, for example, radio frequency, magnetic, acoustic magnetic, dual resonator, or RFID and/or the like that allow the package to be detected by a sensor located at an exit to a store. In a preferred embodiment, the security device may be in the shape of a strip that attaches to the package using an adhesive contained on the strip. In a preferred embodiment, a Sensormatic™ dual resonator tag is used.

In the embodiment illustrated in FIGS. 1-3, security device 106 may be placed on the opposite face of material 10 from that of bar code 102 at a fixed location, such as within 3 inches from the location of the bar code. By placing security device 106 in a consistent location relative to the visible bar code, an employee at the store checkout may easily and consistently place security device 106 in proximity to the equipment used to deactivate the security tag even though the employee may not be able to see security device 106. Further, in the embodiment illustrated in FIGS. 1 through 3, the security device is designed to fit under the shoulder of the breaker within indentation 203 in order to reduce bulk.

Once the security device has been attached, for example at the location illustrated in FIG. 1, material 10 may be formed around device 20 to form security package 30, as is illustrated in FIG. 3. Material 10 is formed around device 20 by folding the sheet at folds 105 illustrated as dashed lines in FIG. 1. Once formed, flaps 103 overlap each other within indentation 201. To seal security package 30, adhesive is applied between flaps 103 to form an adhesive bond. The adhesive is chosen such that the adhesive bond may not be easily broken. As understood by those skilled in the art, different adhesives may perform better with different sheets of material. In a preferred embodiment, 3M™ Scotch-Weld™ Polyurethane Reactive Adhesive TE031 White/Off-White is used in conjunction with a matte rigid vinyl sheet of material. This adhesive has a tensile strength at break of approximately 3,900 psi. Further, as understood by one skilled in the art, other “bonding materials” may be used including the materials used in other techniques such as, for example, chemical bonding, thermal bonding, molecular bonding, fastening (i.e., the use of staples, clips, and/or the like) and/or the like.

While the invention has been described with reference to a particular product, it should be understood that the invention may be applied to any number of products using the principles explained above. Specifically, for each product of a given shape, a package constructed from one or more sheets of material 10 and one or more adhesive bonds may be designed to allow the material to be wrapped around the product such that, when sealed, the product may not be separated from the package without physically breaking the package. FIGS. 4-6 illustrate the process of designing a die-cut sheet used to create a package using another exemplary device—a paintbrush.

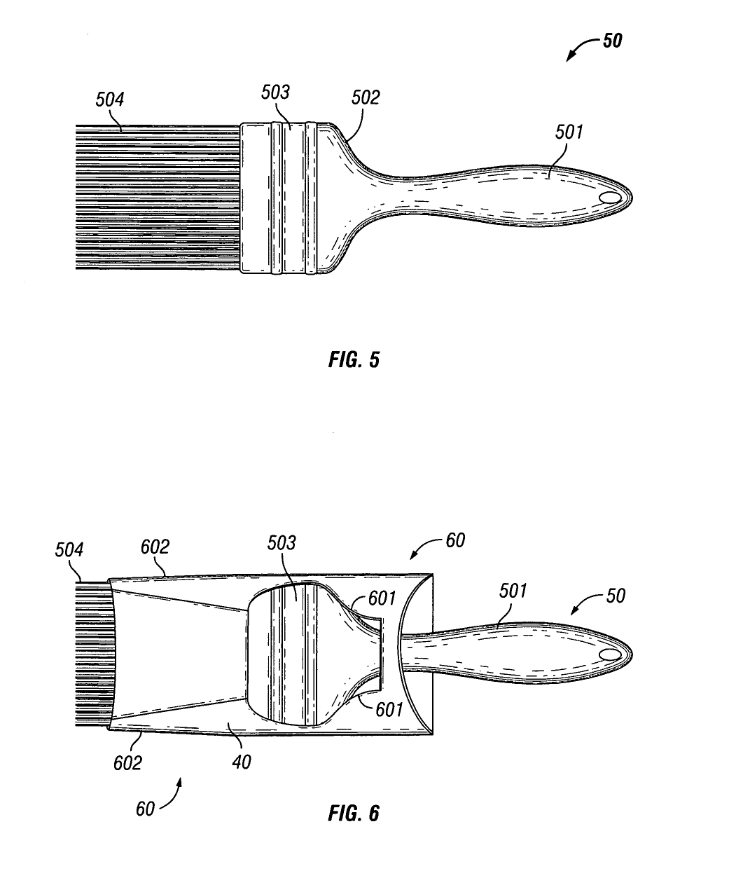

FIG. 4 illustrates a die cut sheet of material 40 according to one embodiment of the invention. Material 40 may chosen in the same way as material 10 discussed above. Material 40 is die-cut in such a way as to wrap around device 50 (a paintbrush) illustrated in FIG. 5 such that, once sealed to form a package, the package may not be separated from device 50 without severing the package. FIG. 5 illustrates device 50 as having a narrow wooden handle 501 that expands outward at point 502 to intersect the metal ferrule 503 which holds the hairs 504 of the brush. To form security package 60 illustrated in FIG. 6, material 40 is folded at folds 401 and then material 40 is wrapped around device 50 such that flap 404 and flap 405 are each folded around device 50 such that the bottom face of flap 404 and flap 405 come in contact with the top face of flap 403. Security package 60 is then formed by sealing the overlapping portion of flap 404 to flap 403 and the overlapping portion of flap 405 to flap 403. It should be understood that security package 60 may contain all the elements discussed above with regard to security package 30 such as product information, a bar code, and a security device.

FIG. 6 illustrates how the design of security package 60 prevents an individual from separating security package 60 from device 50 without tearing or breaking security package 60 by utilizing the shape of device 50. Portions 601 of security package 60 conform to the tapered portion 502 of device 60 such that when an individual attempts to slide security package 60 in the direction of the hairs 504, portions 601 prevent security device 60 from being slid past the metal ferrule 503. Similarly, portions 602 turn slightly inward as they form around the hairs 503 of the brush such that when an individual attempts to slide security package 60 in the direction of the handle 501, portions 602 prevent security device 60 from being slid past the metal ferrule 503. It should be understood that “tearing” is not limited to completely separating two portions of material 10. Rather, turning to FIG. 6, a thief may be able to separate security package 6 from device 5 by creating a small tear between portions 602 allowing the space between portions 602 to expand just enough to allow security package 60 to be slid past the metal ferrule 503 towards the handle 501.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A security package comprising:
a sheet of material having a tensile strength of at least 3000 psi, said material capable of being folded, said material having a range of thickness of between 10 and 20 mil; and
a security device coupled to said sheet of material, said security device capable of detection by a sensor.

2. The security package of claim 1 wherein said sheet of material is vinyl.

3. The security package of claim 1 wherein said sheet of material is rigid vinyl.

4. The security package of claim 1 further comprising:
bonding material positioned on a first portion of said sheet of material and attaching said first portion to a second portion of said sheet of material.

5. The security package of claim 1 further comprising:
printing positioned on at least one portion of said sheet of material.

6. The security package of claim 1 wherein said sheet of material is shaped so as to form a package around a product when folded to form around said product.

7. The security package of claim 6 wherein said sheet of material when formed around said product does not completely enclose said product.

8. The security package of claim 6 wherein said security device contains at least one of: radio frequency, magnetic, acoustic magnetic, dual resonator, RFID technology.

9. A security package comprising:
a sheet of material, said sheet of material substantially more resistant to tearing than a sheet of paper or cardboard of the same thickness;
bonding material on a portion of said sheet of material that overlaps another portion of said sheet of material when said sheet of material is formed around a product to form a continuous package having an inner surface and an outer surface and configured such that said continuous package may not be separated from said product without tearing said continuous package; and
a security device detectable by a sensor coupled to said continuous package and placed on said inner surface of said continuous package such that said security device is not easily visible to a person handling said continuous package.

10. The security package of claim 9 wherein said sheet of material is vinyl.

11. The security package of claim 9 wherein said sheet of material has a thickness between 10 and 20 mil.

12. The security package of claim 9 wherein said continuous package does not completely enclose said product.

13. The security package of claim 1 wherein said security device contains at least one of: radio frequency, magnetic, acoustic magnetic, dual resonator, RFID technology.

14. A method for attaching a security device to a product, said method comprising:
selecting a sheet of material such that said sheet of material is substantially more resistant to tearing than a sheet of paper or cardboard of the same thickness;
coupling a security device detectable by a sensor to said sheet of material such that when said sheet of material is formed around said product said security device is not easily visible;
forming said sheet of material around said product such that at least a portion of said sheet of material is overlapping another portion of said sheet of material; and
securing said overlapping portions of said sheet of material to each other to form a continuous package such that at least a portion of said product is not covered by said continuous package and said continuous package may not be separated from said product without tearing said continuous package.

15. The method of claim 14 further comprising the step of:
printing on at least one side of said sheet of material product information.

16. The method of claim 14 wherein said selecting a sheet of material further comprises:
selecting a sheet of vinyl.

17. The method of claim 14 wherein said selecting a sheet of material further comprises:
selecting a sheet of rigid vinyl.

18. The method of claim 14 wherein said selecting a sheet of material further comprises:
selecting a sheet of material with a thickness between 10 and 20 mil.

19. The method of claim 16 wherein said selecting a sheet of material further comprises:
selecting a sheet of material with a thickness between 10 and 20 mil.

20. The method of claim 14 further comprising the step of:
selecting said security device such that said security device contains at least one of: radio frequency, magnetic, acoustic magnetic, dual resonator, RFID technology.

21. The method of claim 14 wherein said securing is selected from the list consisting of: adhesive bonding, chemical bonding, heating, molecular bonding, and fastening.

22. A method for attaching a security device to a product using a sheet of material with physical properties such that said sheet of material is substantially more resistant to tearing than a sheet of paper or cardboard of the same thickness, said method comprising:
printing product information on said sheet of material;
cutting said sheet of material;
coupling a security device to said sheet of material;
placing said sheet of material around said product such that said sheet of material covers some, but not all, of said product and at least a portion of said sheet of material overlaps another portion of said sheet of material and said security device is not easily visible;
coupling a first of said overlapping portions of said sheet of material to a second of said overlapping portions of said sheet of material such that said product can not easily be separated from said sheet of material without breaking said sheet of material or said adhesive bond.

23. The method of claim 22 wherein said cutting said sheet of material comprises die cutting said sheet of material using a die designed specifically for said product or family of products of said product.

24. The method of claim 22 wherein said cutting said sheet of material further comprises:
cutting a hole in said sheet of material such that when said sheet of material is placed around said product, said hole will accommodate a protuberance on said product.

25. The method of claim 22 wherein said cutting said sheet of material further comprises:
cutting said sheet of material such than when folded around a product, a portion of said sheet of material is formed around a narrow cross section of said product adjacent to a wider cross section of said product such that said portion of said sheet of material may not be slid past said narrow cross section of said product onto said adjacent wider cross section of said product.

26. A method of attaching a security device to a product, said method comprising:
folding a sheet of material around said product, said sheet of material having a thickness between 10 and 20 mil and a tensile strength of at least 3000 psi, said material having been formed to be folded around contours of said product such that when at least one portion of said material is secured to another portion of said material, said folded material cannot be removed from said product without physically breaking said material; and
securing said portions to one another.

27. The method of claim 26 wherein said securing is selected from the list consisting of: adhesive bonding, chemical bonding, thermal bonding, molecular bonding, and fastening.

28. The method of claim 26 further comprising:
prior to folding a sheet of material around said product, attaching a security device detectable by a sensor to said sheet of material such that when said sheet of material is folded around said product, said security device is not easily visible.
